(19) United States
(12) Patent Application Publication
(10) Pub. No.: US 2002/0125113 A1
(43) Pub. Date: Sep. 12, 2002

(54) Contacting incremental encoder

(76) Inventors: Mayur Bhakta, Los Angeles, CA (US); Paul Gratzinger, Moreno Valley, CA (US); Larry Kucharski, Moreno Valley, CA (US); Richard Baily, Riverside, CA (US); Dermot Healy, Carrigaline (IE)

Correspondence Address: CHRISTIE, PARKER & HALE, LLP, 350 WEST COLORADO BOULEVARD, SUITE 500, PASADENA, CA, 91105, US

(21) Appl. No.: 09/801,022

(22) Filed: Mar. 6, 2001

(51) Int. Cl. H01H 19/00

(52) U.S. Cl. 200/11 R

(57) ABSTRACT

An encoder assembly is disclosed which comprises a drum-like rotor having an outer circumference and a central bore with at least one slot, and a plurality of encoder elements arrayed around the outer circumference of the drum-like rotor. The assembly further comprises a shaft having a diameter sized to fit into the central bore, and having a flattened key which is configured to fit into the at least one slot. The rotor and shaft fit into a housing having an inner section sized to receive the drum-like rotor and encoder elements. The inner section has an opening along one side such that the inner section incompletely encloses the circumference of the rotor. There is also at least one spring contact locatable within the housing such that it can make contact with the encoder elements through the opening in the inner section of the housing.

### BACKGROUND OF THE INVENTION

The present invention relates to electronic encoders, both rotary and linear, used in the electronics industry for position, speed, and direction control.

Electronic incremental encoders produce a single output for a given displacement. Rotary encoders are multi-turn sensors utilizing optical, mechanical, or magnetic indexing around the circumference of rotation, and can be used to measure either position or velocity. Such encoders serve as multiple selector switches or positional sensors to detect angular deflection, etc., converting positional data into position-relevant electrical signals.

Encoders are ubiquitous components of electronic devices. Advances in electronics have led to smaller and smaller devices, requiring smaller and smaller components, and multiple functions in each component to reduce the number of components. However current encoder devices are often limited by design constraints in the fabrication of the sensor element, which often involves a printing process. Most encoders use printing techniques to apply a contact design to a base substrate (usually a printed circuit board). This substrate is usually then affixed to the moving element in the unit and the whole assembly moved past the contact point to pick off the electrical signals. The printed circuit board does not contribute directly to the functionality, but is simply carrying the contact area. Furthermore, encoder elements are often made up of many parts, making them cumbersome to assemble during production. Finally, the fabrication and assembly process is relatively expensive, both for parts and labor. There exists a need for an easy-to-assemble, inexpensive general purpose encoder which can be manufactured to any necessary size, particularly very small sizes, and incorporate multiple functions, such as a contact switch.

### SUMMARY OF THE INVENTION

The encoder assembly of the invention combines the rotor and contacting element into a single unit, has relatively few parts, is easily assembled and sealed, and requires no printing, thereby reducing the cost of manufacturing and labor. In one embodiment, the encoder is molded of plastic, and incorporates a tactile switch. Some embodiments combine the rotor and the contacting elements into a single unit, with the exterior connect leads and the contact spring as a single unit (no interface), and by incorporating an optional tactile switch within the design, to make a very small assembled encoder.

In one embodiment, the encoder assembly of the invention features a drum-like rotor having an outer circumference and a central bore having at least one slot, with a plurality of encoder elements arrayed around the outer circumference of the drum-like rotor. There is a shaft which has a diameter that is sized to fit into the central bore of the rotor. The shaft has a flattened key which is designed and configured to fit into the slot or slots formed within the central bore of the rotor. In one embodiment, the shaft has two ends, and the key is located at one end. The encoder assembly also has a housing, which has an inner section sized to receive the drum-like rotor and encoder elements. The inner section of the housing has an opening along one side such that the inner section incompletely encloses the circumference of the rotor.

Manufactured within the housing or to fit within the housing is at least one spring contact, preferably more, which is located or locatable within the housing such that it can make contact with the (encoder elements through the opening in the inner section of the housing. The encoder assembly of the invention features in one embodiment a shaft mounted coaxially with the drum-like rotor, so that the key, when fit into the slot, turns the rotor when the shaft is turned. In one embodiment, the shaft is capable of axial movement when the encoder assembly is assembled. In such a configuration, axial movement of the shaft activates a contact switch located at the end of the shaft. In one embodiment the contact switch has a conductive metal dome mounted between the shaft and a conductive pin, such that axial movement of the shaft depresses the dome until it contacts the first pin and closes the switch. In a further embodiment, the switch further comprises a second conductive pin which is electrically coupled to the first conductive pin when the dome contacts the first and second pins.

The spring contact within the housing completes a circuit upon contact with one of the plurality of encoder elements. Preferably, the spring contact is a beam arm spring, and is embedded or assembled on a substrate with conductive leads away from the assembly. This provides the advantage that there is no interface required between the spring contact and the exterior connect leads, making the encoder easier to assemble and providing reliable, long lasting contacts.

The invention features a rotor that is a single piece, preferably molded of a plastic or polymer. Alternatively, the encoder elements at least can be molded of a conductive polymer. In preferred embodiments, the encoder elements are molded on the rotor, embossed with conductive metal film, or molded with a plating plastic. In one embodiment, the housing is also molded of plastic, and can be a single piece. The shaft can also be molded of plastic, or be machined plastic or machined metal. These component parts are manufactured using a two shot molding process, and have the advantage of being relatively simple and inexpensive to manufacture. In the two shot molding process, a first rotor piece is molded in a first shot of a first plastic, and a second rotor piece is molded in a second shot adjacent to the first piece of a second plastic. Portions of the second shot can be exposed through the first shot, and the exposed portion can be of a plastic selected for a desired property according to the intended function where it shows through the other plastic piece. Desired properties can include platability, non-platability (electroplating or electroless), magnetic properties, conductivity, or color.

### BRIEF DESCRIPTION OF THE DRAWINGS

FIG. 1 is an exploded perspective view of the component parts of an encoder of the invention.

FIG. 2 is a perspective view of an assembled encoder of the invention.

FIG. 3 is a view of an assembled encoder of the invention from the side that contacts an optional push switch.

FIG. 4 is a view of the encoder of FIG. 3 showing a conductive metal dome which serves as the contact switch in place to be activated by depression of an external switch button.

FIG. 5 is a perspective view of a spring contact and substrate according to the embodiment in FIG. 1.

FIG. 6 is a perspective view of a rotor according to the embodiment of FIG. 1 showing the slots in the inner bore and key stop.

FIG. 7 is a perspective view of a contact switch of the invention.

FIG. 8 shows a rotor first shot as it would appear from the molding tooling.

FIG. 9 shows the rotor second shot as it would appear if the first shot was completely removed.

FIG. 10 shows the rotor complete with both first shot plastic and second shot plastic.

### DETAILED DESCRIPTION

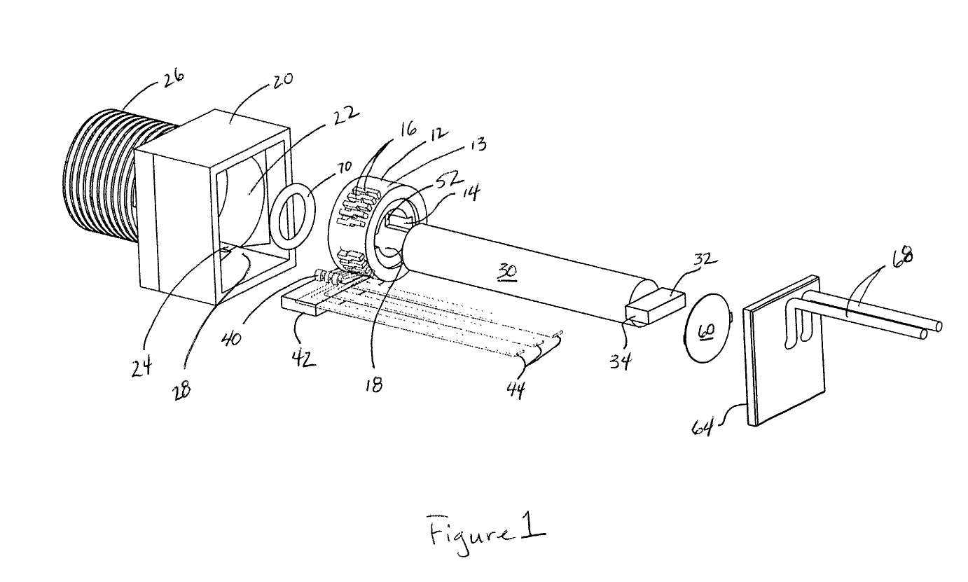

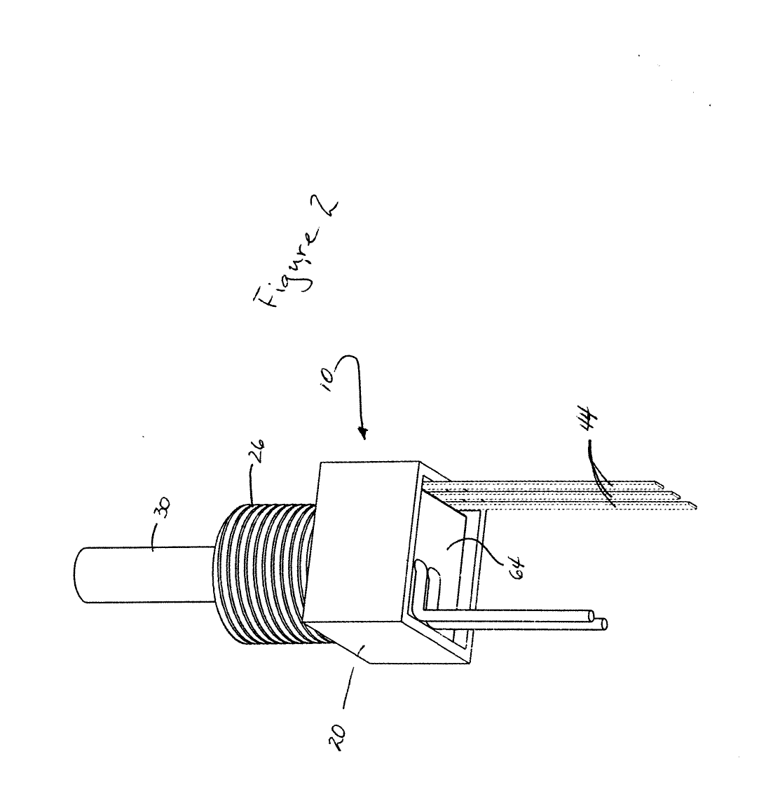

The encoder of the invention is configured to combine multiple functions efficiently in a single functional unit. The encoder assembly of the invention has the contacting encoder elements of the rotor on the radial/lateral plane instead of the more usual bottom plane of the rotor. The assembled encoder of the invention is comprised of a housing, a drum-like rotor within the housing, a shaft extending through the rotor and housing, and an optional momentary contact switch. FIG. 1 shows an exploded view of one embodiment having these and associated elements, and FIG. 2 shows an encoder unit assembled.

With reference to FIGS. 1 and 2, an encoder assembly 10 has a housing 20 to fit a rotor 12. The exterior of housing 20 is shaped in any manner to be easily installed in the electronic component of which it will be a part; it is a rectangular shape in this embodiment. Flat sided shapes such as a rectangle can be advantageously used as an anti-rotation feature as a unit locking nut (not shown) is tightened or loosened. Flat sides also allow for each of multiple units to be aligned in the same orientation. The housing 20 optionally has a hollow threaded proximal extension 26 to facilitate installation of the encoder in its electronic component. Standoffs (not shown) can be included to facilitate board mounting. The housing has a sturdy panel interface to prevent wear to the threads and has also a flat housing body to ensure a flush fit against a panel (not shown) onto which it may be attached. The threaded extension 26 may have a beveled open end to allow for easy threading through the panel and for easy attachment of the locking nut. The shaft entryway also has a beveled entry point to facilitate smooth rotation and lateral movement of the shaft by eliminating flash at this point. The inside of the housing 20 has an inner section 22 designed to fit the rotor 12 within it. The inner section 22 of the housing 20 does not completely enclose the rotor 12, but has an opening 24 in its side. The housing has distal surface with a slot-like opening 28, the purpose of which will be described below.

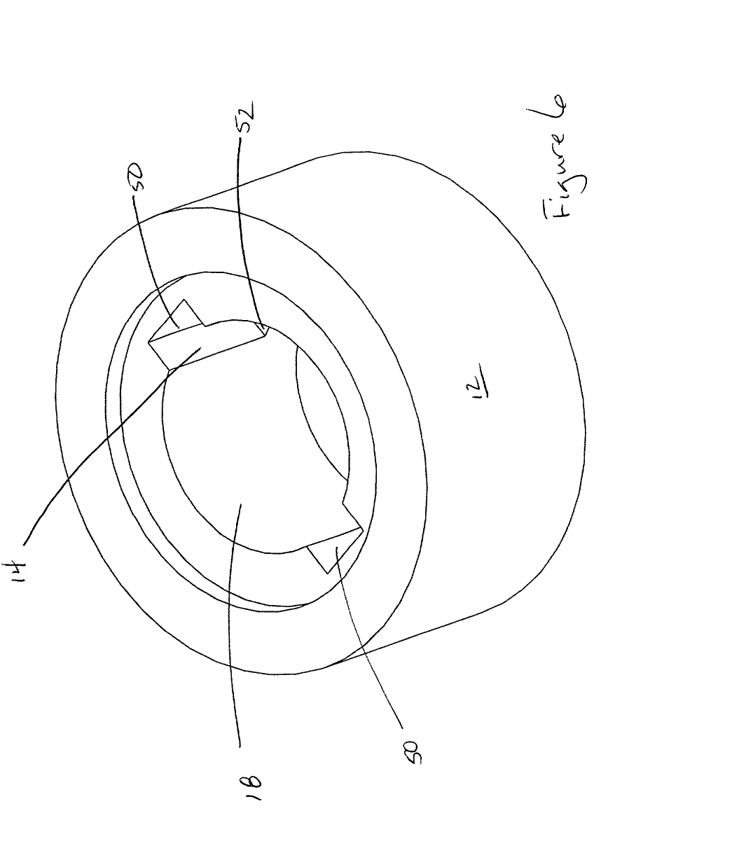

The rotor 12 has a substantially cylindrical, drum-like shape, with an outer circumferential surface 13 and an axial bore 18. The bore 18 of the rotor 12 is centrally located in the embodiment shown, and is punctuated by one or more axially-extending slots 14 which may, but need not, be symmetrically arranged (if more than one slot). In the embodiment shown in FIGS. 1, 3 and 6, there are two slots 14 which are diametrically opposed to each other in the rotor 12. Referring to FIG. 6, the slots 14 do not extend through the entire axial length of the bore 18, but have an open end 50 (i.e., where the slot extends to the end of the bore of the rotor) on one end of the rotor 12 and a blind end or key stop 52 within the bore 18.

A pattern of conductive encoder elements 16 is arrayed on the outer circumferential surface 13 of the rotor. The encoder elements 16 may be arranged in any desired pattern. Their conductivity may be conferred by embossing with a conductive metallic film or overlay, for example, or they may be molded of a conductive material, such as a conductive polymer. Preferably, they are formed of a plastic material that is activated so as to be platable with a metal plating or of a conductive plastic. Etching or any other means known in the art of designing and/or printing the conductive encoder elements may also be used.

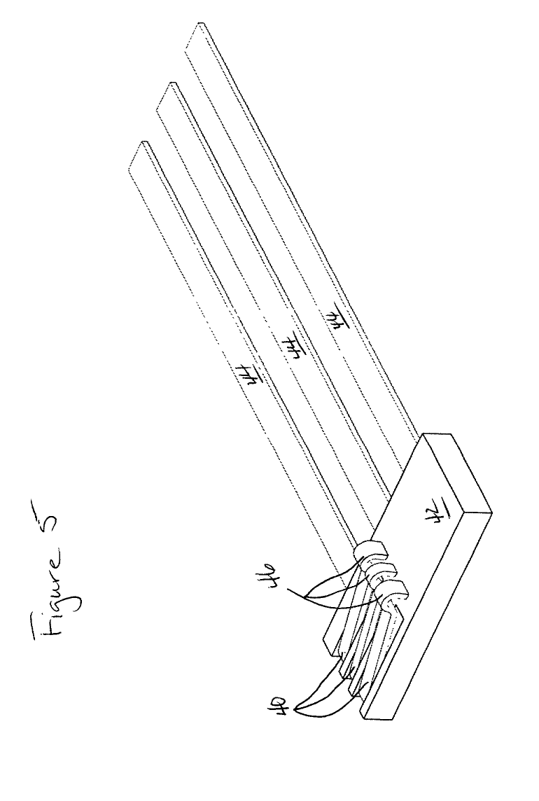

A substrate 42 is sized to fit within housing 20. The substrate has at least one spring contact 40, with a substrate having three spring contacts illustrated in the embodiment of FIG. 5. Each of the spring contacts 40 has a corresponding encoder lead 44 associated with it, with the encoder leads extending away from the substrate 42. In some embodiments, a plurality of spring contacts 40 and encoder leads 44 are embedded within the substrate 42, which is preferably made from a moldable, non-conductive polymer. The substrate 42 is designed to fit within the housing 20 under the opening 24 of the inner section 22. As shown in FIG. 5, the spring contacts are preferably beam arm springs having head portions 46. Spring head portions 46 are elevated above the arm of the beam arm spring 40 such that a relatively small area of contact, between only the head portion 46 and a contact target, is made. The contact target is intended to be the encoder elements 16 in the assembled encoder assembly, and the spring contacts 40 are therefore designed to be located on the substrate 42 at a position where the head portions 46 will extend through the opening 24 of inner section 22 of the housing 20 in the assembled encoder.

A shaft 30 is designed to fit axially through the inner bore 18 of the rotor 12 (FIG. 1). The the shaft 30 is of a cross-sectional shape and size that fits within and mates with the bore 18. For example, a square cross-section shaft and bore could be constructed. In the embodiment shown, the shaft and bore have a circular cross-section. The shaft 30 includes a flattened key element 32 which is designed to fit into the slot or slots 14 that interrupt the peripheral surface of the bore 18. The key element 32 has opposed edges 34 that fit into the slots 14, but they cannot pass the key stop 52 (see FIG. 6). The key element 32 can be located anywhere along the length of the shaft, as long as the length of shaft 30 that extends axially through the rotor is sufficient to make desired attachments (to a knob, for example) in the device in which the encoder assembly is installed. In the embodiment shown in FIG. 1, the key element 32 is located at the distal end of the shaft 30.

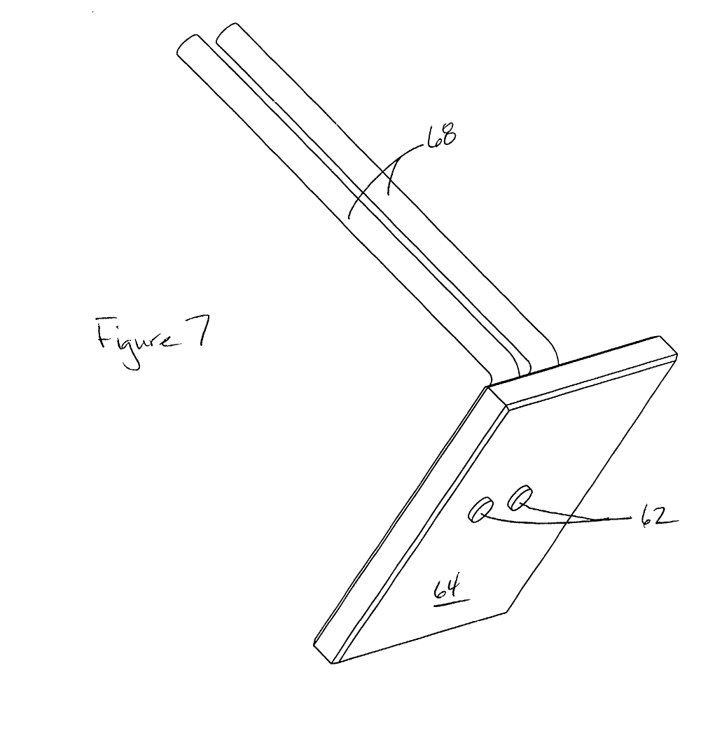

The encoder assembly of the invention optionally includes a momentary contact switch, activatable by depressing the shaft 30 axially. As seen in FIGS. 1 and 7, the contact switch comprises a switching element in the form of a conductive dome 60, preferably made of metal, which is sufficiently flexible so as to be deformed centrally when the distal end of the shaft 30 or the key element 32 is pressed against its convex proximal surface. The conductive dome is preferably held in place with flanges that fit into recesses on the contact switch substrate or the rotor. It is preferable that the dome does not turn with the rotor, to minimize wear on the rotor. The contact switch also includes at least one conductive pin 62 (see FIG. 7) arranged in or on a switch substrate 64. In preferred embodiments, there are two conductive pins 62, which when electrically coupled, form the closed switch. Alternatively, contact between the conductive dome 60 and the pin 62 closes the switch. The pin or pins 62 are coupled to switch leads 68.

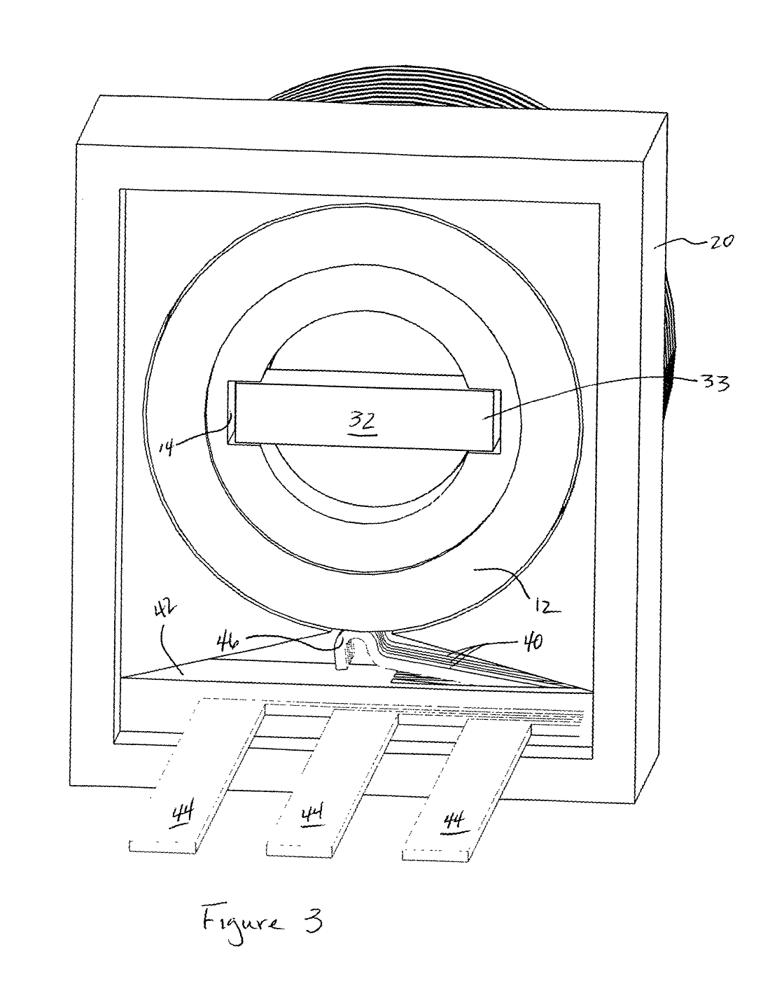

Referring to FIGS. 1 and 3, to assemble the encoder, the shaft 30 is slid through the bore 18 of the rotor. The key element 32 is oriented to fit into slot 14 at the open end 50 of the bore 18, and the shaft is axially adjusted until the edges 34 on key element 32 comes to rest on the key stops 52 of the slots 14. The assembled shaft and rotor are inserted through the inner section 22 of housing 20 until the rotor is located within the inner section 22, and the shaft 30 extends through the hollow threaded proximal extension 26 of the housing. The shaft 30 can be rotated in order to spin the rotor and thereby generate electrical signals on the encoder leads 44. The shaft 30 can also be depressed against the convex surface of the dome contact 60 in order to cause a switch closure which shows as a short circuit across the output pins 62. The exposed proximal end of the shaft 30 accommodates various different mechanical adaptors to allow for various different knob configurations (not shown). The shaft area is sealed by a hermetic O-ring seal 70.

The substrate 42 containing the spring contacts 40 and leads 44 is inserted into the housing 20 below the opening 24 in the inner section 22 of the housing so that the spring heads 46 are aligned with the opening 24 in the inner section of the housing 22. The spring heads 46 are thus positioned so that, within the range of travel of the spring contacts 40, the spring heads 46 extend into or through the opening 24 far enough to make contact with the encoder elements 16 in the assembled encoder (FIG. 3). The housing may initially be formed with an interior skiving nub (not shown) to help locate the spring contact substrate 42 (lead frame assembly) toward the proximal end of the slot-like opening 28 in the housing (FIG. 1). This is accomplished when the skiving nub is torn away as the substrate 42 is pushed into the slot-like opening 28, thereby ensuring a tight fit at both the limits of tolerance. Likewise, skiving nubs (not shown) can locate the switch substrate 64 in the housing.

The shaft 30 passes through both the rotor and the O-ring 70 and extends to the exterior of the proximal side of the housing. In effect, the O-ring is compressed by the housing, by the rotor and by the shaft. This ensures a good seal for the unit.

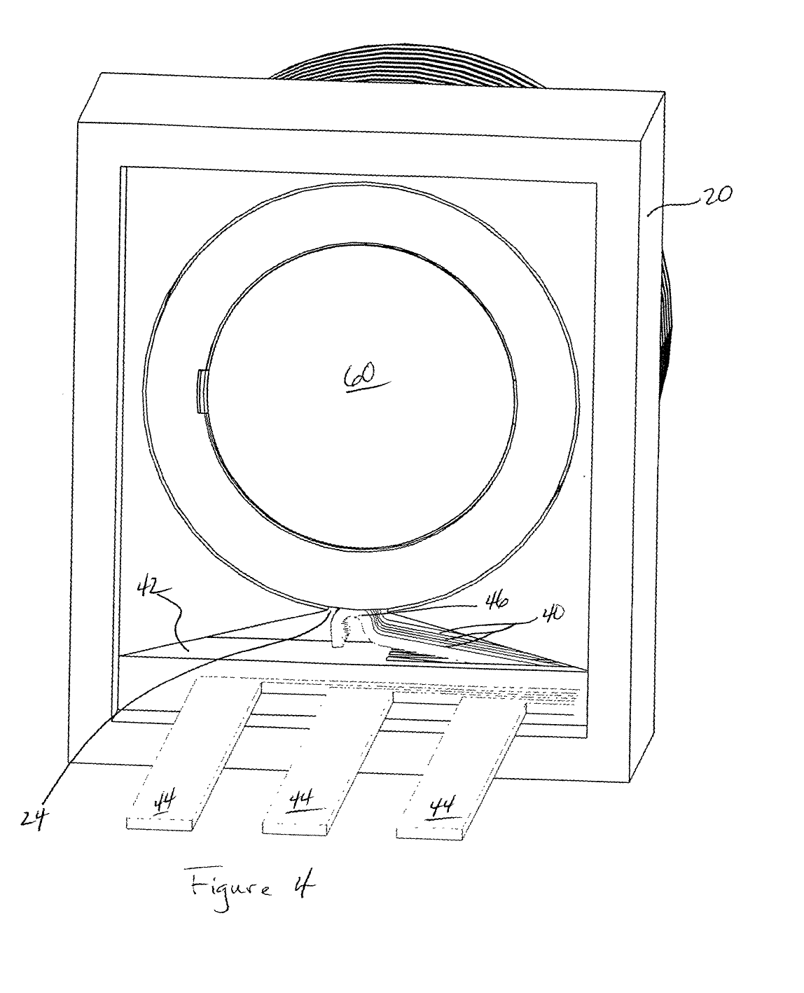

If a tactile switch, such as a momentary contact switch, is included in the encoder assembly, it is configured in the assembled package as follows. The conductive dome 60 is placed adjacent to the distal end of the shaft 30 or the key element 32 (FIG. 4), and the switch substrate 64 is placed adjacent to the conductive dome 60 so that the conductive pin or pins 62 are beneath the conductive dome. As can be seen in FIG. 2, the switch substrate 64 is sized to fit within the housing 20, where it can be sealed in place, as with epoxy or any other sealant. The switch substrate is positioned within the housing at a point where the outer periphery of the conductive dome 60 abuts the switch substrate 64 but the central portion of the dome does not. Further, the switch substrate and dome are within the axial range of travel of the shaft 30, such that when the shaft 30 is depressed, it can deform the dome's central portion such that it makes contact with the switch pin or pins 62. In the embodiment shown in FIG. 1, the key element 32 of the shaft 30 resiliently deforms the dome 60 when the shaft is axially depressed. The conductive dome 60 makes contact with both of pins 62, electrically electrically coupling them and closing the tactile switch.

The portion of shaft 30 that extends through the threaded proximal extension 26 of housing 20 can be fitted with a knob or button ending (not shown), such that it may be both rotated to rotate the encoder rotor, and depressed axially to activate the momentary contact switch. Turning the shaft 30 in the assembled encoder 10 also turns the rotor 12, because the key element 32 fits into the slots 14 of the rotor 12 and locks rotational movement of the two components together. As the shaft 30 and rotor 12 are rotated, each encoder element 16 is exposed in turn to the spring heads 46 as it passes sequentially over the opening 24 in the inner section 22 of the housing 20.

The rotor and encoder element can be manufactured using three specific methods: two shot molding involving a platable plastic and a non-platable plastic, two shot molding involving a conductive polymer and a non-conductive polymer, and embossing a non-conductive plastic or polymer with a conductive metallic film. The two shot molding provides an interior molded part that is patterned with the encoder element artwork in mind, and then this produced piece is placed into another mold to produce the remaining portion. Thus, the encoder element pattern is formed in the first mold, and the remainder of the rotor is formed in the second mold. The encoder element portion can be either a plastic that is itself conductive, or a plastic that is activated to accept metallic plating. The third option is to emboss a thin sheet of conductive metal, such as copper, onto the rotor in the correct pattern.

In some embodiments, the contact spring retains a flexible portion (e.g., abeam arm) that allows flexing to adjust to discontinuities on the surface of the rotor bearing the encoder elements, and it also has a radial contacting surface such that the contact point is minimized to a point of tangency between the rotor and the contact spring. In one embodiment, the contact spring is insert molded right into the housing. In another embodiment, the contact spring is insert molded into a different piece part and assembled into the encoder package (as shown in the embodiment of FIGS. 1-7).

The shaft of the encoder assembly in some embodiments allows movement in the axial direction but none in the radial direction. Movement of the shaft in the assembled encoder is limited in the axial direction by the keys stops 52 in the rotor in the outward or proximal direction, and by the tactile dome 60 in the inward or distal direction. The shaft can be formed of molded or machined plastic, or machined metal. The conductive dome 60 can be of the sort used in known tactile switches (e.g., available from Boums, Inc., Riverside, Calif.). It is preferably formed from a thin piece of flexible conductive metal, and it is designed to contact swaged conductive pins 62 that have the correct height and diameter to be readily contacted by the resiliently flexible deformation of the dome.

The encoder package is assembled and sealed using, for example, epoxy on the distal end of the housing and a hermetic O-ring seal on the shaft area. An O-ring gland (not shown) is molded into the housing, and works in conjunction with a corresponding gland (not shown) molded into the rotor. The O-ring seal serves as a process seal as well as a functional seal for a certain number of cycles before the effects of frictional wear degrade the integrity of the rubber seal.

In some embodiments, the encoder assembly is quite small, for example, about a 6 mm² housing. All parts can molded of plastic, keeping costs reasonable. The design is quite versatile, and allows for different combinations of products to be combined (e.g., switches, potentiometers, and encoder). This versatility is made possible by moving the encoder elements from the housing onto the outer surface of the rotor.

Encoders of the invention are preferably made using techniques that allow the sensor element within the encoder to be manufactured without use of printing technologies or expensive precision parts, but instead using advanced molding technologies to produce piece parts from various types of plastic. These molding technologies include, but are not limited to, use of platable grades of plastic which can be subsequently processed through an electrolytic or electroless plating process to achieve a conductive surface, use of conductive plastics, use of nonplatable grades of plastic to be used as a masking material to prevent certain areas of the platable plastic from taking up conductive plating materials in the plating process, hot embossing of conductive and non conductive foils onto a surface of appropriate plastics, and laser structuring.

In the encoders of the invention, there is no printed circuit board, and the process of printing the circuit pattern onto the printed circuit board and the process of affixing the printed circuit board to the moving element are both eliminated. The methods of the invention use plastic molding technologies and electroplating technologies, among others, to apply a circuit pattern onto a piece of plastic which is formed into the required shape to perform the function of the active element.

In a preferred embodiment, the product is produced using a two shot molding process. The first shot mold is a conductive or platable plastic material, whereas the second shot mold is a commercially available plastic material suitable for a housing. The Example below illustrates various processes for molding and plating the encoder of the invention. The Example is intended to illustrate aspects of the invention and is not to be construed as limitations upon it.

### EXAMPLE

Two Shot Molding

“Two shot molding” technology allows for the manufacture of plastic parts using, for example, two plastics with different properties. Two shot molding is described in U.S. patent application Ser. No. 09/592,526, the full disclosure of which is herein incorporated by reference. In two shot molding, the first plastic is molded in a first molding step or “first shot” by injecting a first plastic material into a mold to form ta first shot molded assembly, which is placed into a second mold. A second plastic material is injected into a second mold, on top of or over the first shot plastic piece, in a second molding step or “second shot.” The first plastic may appear through openings in the second plastic (e.g., through open areas designed into the mold) so that it is accesible and not covered by the second plastic. The first plastic can be selected for properties that are desirable in the areas where it is exposed through the second plastic, or vice versa. In general the two plastics are chosen for properties which are distinct from each other, e.g., one may be conductive, magnetic, or platable and the other not; one may have a specific color and the other a different color, etc. Platable or conductive plastics may have metallic fillers, for example palladium, to make them conductive or render them chemically receptive to metallic plating. The plastics may also be reinforced with non-metallic fibers, such as glass, in order to enhance their mechanical properties.

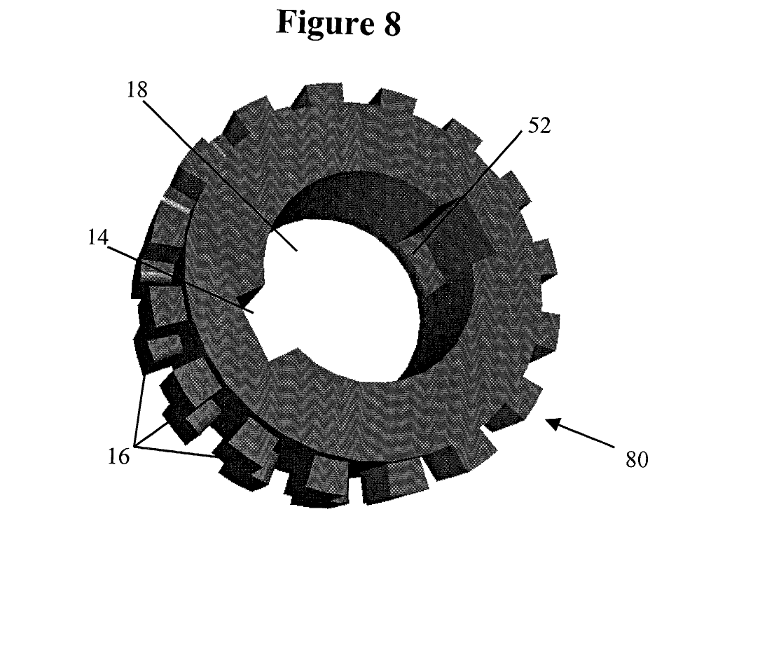

To illustrate the two shot process, FIG. 8 shows a first shot rotor portion 80 as it would be formed in a first molding tooling (not shown) for a 16 pulse per revolution device. The first shot portion 80 is formed of a plastic material that has been or can be chemically activated to accept metal plating. It includes a bore 18 appropriately dimensioned to allow the shaft through but to minimize lateral play. The bore 18, in turn, is formed with the slots 14 for the shaft key element 32 so that rotation of the shaft results in equal rotation of the rotor. The first shot portion 80 contains the pattern of encoder elements 16 that is conductive or will eventually be plated up to form the active portion of the encoder. If a plating plastic is used, the step of applying metallization to selected areas comprises the steps of applying a sequence of conductive layers through both electroless and electrolytic deposition in selected areas where the first shot material is accessible through the second shot material.

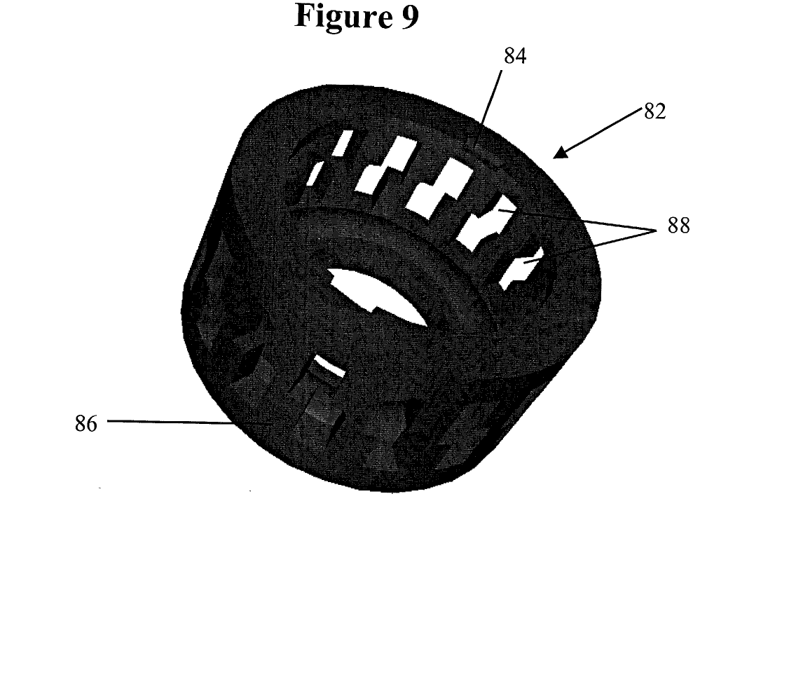

FIG. 9 shows a second shot rotor portion 82. In practice, the second shot portion 82 is not formed separately from the first shot portion 80, but rather it is over-molded on top of the first shot portion 80. The second shot portion 82 may contain location slots 84 for the dome contact 60, a wear surface 86 for running on the contact plate, and openings 88 through which the first shot encoder pattern 16 will appear. Alternatively, and in presently preferred embodiments, the location slots 84 are located in the contact substrate such that the dome does not turn with the rotor, thus reducing wear on the dome and/or contact pin in the event that the dome and one of a plurality of contact pins are in constant contact.

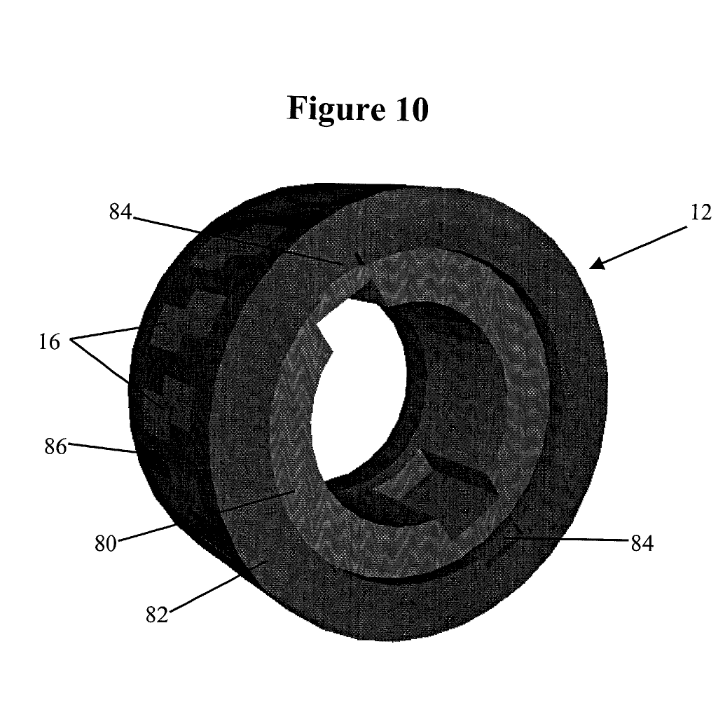

FIG. 10 shows a two shot molded rotor 12 in its completed form with both first and second shot portions 80, 82 molded together. It shows the first shot encoder element pattern 16, clearly visible on the side of the rotor. It has a wear surface which will run on the O-Ring (not shown), and the wear surface 86 which will run on the contact plate. It also shows a rotor location slot 92 and the dome contact location slots 84.

Hot Embossing

In some embodiments, an encoder, either rotary or linear/planar is manufactured by the technique of hot embossing a conductive foil onto the surface of the plastic. In the hot embossing technique, a conductive foil is pressed onto the plastic substrate and heat is applied via a patterned tool. In the areas where the heat is applied, the conductive foil adheres to the plastic. After cooling, the foil can be peeled off from the areas where it has not adhered, leaving the foil adhered to the plastic in a pattern to match the heated tooling used. This foil then becomes an integral part of the plastic substrate.

Laser Structuring

In some embodiments, an engineering plastic is so designed as to have an unstructured state where the plastic has one set of properties, and a structured state where the plastic has an opposite or different set of properties. The change from unstructured to structured state is achieved by bombarding the surface of the plastic with energy, for example laser energy. There are essentially 2 forms of laser structuring.

(1) Additive. In this case, the laser applies the energy in a pre-programmed pattern to an engineering plastic whose unstructured state has the property that the plastic is not platable, for example. Only the areas exposed to the laser beam become structured. In this case, the laser structuring changes the properties of the surface so that the exposed plastic becomes platable. In subsequent steps, a plating material is applied to the structured areas in the desired pattern.

(2) Subtractive. In this case, a platable engineering plastic is fully plated with a metal layer so that the metal covers more than the required pattern area. Generally, the outer surface is completely plated. The laser subsequently burns off the unwanted plating by applying bursts of laser energy onto the plating and effectively vaporizing it. The remaining plating is left in the desired pattern.

Plastic Molding

In the case of all embodiments of the invention, it is desirable to have be able to include additional desirable features without increasing the piece part count or complexity of assembly. When using plastic to form the active part of the encoder assembly, it is possible to include additional features, including but not limited to holes, slots, indentations, bumps, vias, extrusions, contact points, actuation surfaces, wear surfaces, grooves, skiving nubs and guides. This is all accomplished at the mold design stage. The required features are included in the mold design so that they are automatically produced as the parts are molded.

Metal Plating

This technique involves applying a layer of metal to the surface of the product where the surface has been suitably prepared and patterned. This can be accomplished by techniques such as two shot molding, hot embossing, and laser structuring. The plating can be applied by using either an electrolytic process or an electroless process as are known in the art.

In preparing the exposed surfaces of the first shot molded material to accept metallization, a series of cleaning, swelling, and etching steps are generally applied, such as would be known to one of ordinary skill in the art, in order to sufficiently activate the surface of the platable plastic material without adversely affecting the surface of the non-platable plastic. The surface of the non-platable plastic material remains inert and hydrophobic. The plating process can be a combination of electroless and electrolytic processes. For example, first, electroless copper is deposited on the prepared areas of the first shot molded plastic to a thickness of about 2-4 μm, then a layer of copper is deposited in an electrolytic process over the electroless layer to a thickness of about 30-40 μm. A layer of nickel having a thickness of about 2-6 μm is then deposited over the copper using an electroless process, primarily as a diffusion barrier, but also because of its harness and resistance to wear. Additional or different layers may be added as desired.

Some methods of the invention use standard two shot molding techniques followed by electroplating to manufacture the rotor, but other embodiments use two shot molding plastics where one plastic is already conductive and requires no subsequent plating, or single engineering plastic which is subsequently hot embossed with a conductive foil to achieve the required pattern, or single (engineering plastic whose properties are alterable by laser structuring so as to make a portion platable in the required pattern, or single engineering plastic which is inherently platable, followed by electroplating and laser structuring to remove plating to leave a conductive pattern as required. The main feature is the ability to apply electrical circuitry to the precision plastic part and to include many mechanical functional details in the same precision plastic part.

One of the important features of any encoder is the resolution or number of pulses per revolution (p.p.r.). The higher the number of pulses per revolution of the rotor, the smaller is the step size that can be resolved or detected by the encoder. In many miniature encoders, this number of pulses per revolution is reduced by the limitations of the physical size of the rotor. In this invention, because of the new technologies used, it is possible to dramatically increase the p.p.r. count for any given size of rotor. This is due primarily to the fine-line molding techniques employed and by the use of lasers to structure the surface patterns.

The encoder assembly of the invention allows for numerous features to be incorporated into a very small package. The design is cost-effective, as all parts can be plastic molded and assembled in a short amount of time. The encoder assembly incorporates a minimal number of piece parts; having a maximal number of functions.

The preceding description has been presented with references to presently preferred embodiments of the invention. Persons skilled in the art and technology to which this invention pertains will appreciate that alterations and changes in the described structures and methods can be practiced without meaningfully departing from the principle, spirit and scope of this invention.

Accordingly, the foregoing description should not be read as pertaining only to the precise structures and methods described and shown in the accompanying drawings, but rather should be read as consistent with and as support for the following claims, which are to have their fullest and fairest scope.

What is claimed is:

1. An encoder assembly comprising:
a drum-like rotor having an outer circumference and a central bore having at least one slot;
a plurality of encoder elements arrayed around the outer circumference of the drum-like rotor;
a shaft having a diameter sized to fit into the central bore, and having a key, wherein the key is configured to fit into the at least one slot;
a housing having an inner section sized to receive the drum-like rotor and encoder elements, the inner section comprising an opening such that the inner section incompletely encloses the circumference of the rotor; and
at least one spring contact locatable within the housing such that it can make contact with the encoder elements through the opening in the inner section of the housing.

2. The encoder assembly of claim 1 wherein the shaft is mounted coaxially with the drum-like rotor, and the key, when fit into the at least one slot, turns the rotor when the shaft is turned.

3. The encoder assembly of claim 1 wherein the shaft is capable of axial movement when the encoder assembly is assembled.

4. The encoder assembly of claim 1 wherein shaft has two ends, and the key is located at one end.

5. The encoder assembly of claim 3 further comprising a contact switch wherein axial movement of the shaft activates the switch.

6. The encoder assembly of claim 5 wherein the contact switch comprises a conductive metal dome mounted between the shaft and a first conductive pin, such that axial movement of the shaft depresses the dome until it contacts the first pin and closes the switch.

7. The encoder assembly of claim 6 wherein the contact switch further comprises a second conductive pin, the second conductive pin being electrically coupled to the first conductive pin when the dome contacts the first and second pins.

8. The encoder assembly of claim 1 wherein the spring contact completes a circuit upon contact with one of the plurality of encoder elements.

9. The encoder assembly of claim 1 wherein the spring contact is a beam arm spring.

10. The encoder assembly of claim 1 wherein the rotor is a single piece.

11. The encoder assembly of claim 1 wherein the rotor is molded of a conductive polymer.

12. The encoder assembly of claim 11 wherein the encoder elements are molded on the rotor.

13. The encoder assembly of claim 11 wherein the encoder elements are embossed with conductive metallic film.

14. The encoder assembly of claim 1 wherein the encoder elements are molded of a plating plastic.

15. The encoder assembly of claim 11 wherein the encoder elements comprise a plating plastic.

16. The encoder assembly of claim 1 wherein the housing is molded of plastic.

17. The encoder assembly of claim 1 wherein the shaft is molded of plastic.

18. The encoder assembly of claim 1 wherein the shaft is machined metal or plastic.

19. The encoder assembly of claim 1 wherein the contact spring and the leads connecting to the exterior of the assembly are formed as a single unit.

20. The encoder assembly of claim 1 wherein the rotor is molded using a two shot molding process wherein a first rotor piece is molded in a first shot of a first plastic, and a second rotor piece is molded in a second shot adjacent to the first piece of a second plastic.

21. The encoder assembly of claim 20 wherein portions of the second shot are exposed through the first shot.

22. The encoder assembly of claim 20 wherein at least one of the plastics is selected for a desired property according to the intended function where it shows through the other plastic piece.

23. The encoder assembly of claim 22 wherein the desired property is selected from platability, non-platability, magnetic property, conductivity, and color.

24. A rotor assembly for a rotary encoder, the assembly comprising:
a tubular plastic inner portion having at least one encoder element arrayed radially along an outer circumference of the inner portion, and
a plastic outer portion arrayed radially along the outer circumference of the inner portion such that at least a portion of the encoder element is left uncovered,
wherein the plastic of the inner portion has at least one characteristic that is different from the plastic of the outer portion.

25. The rotor assembly of claim 24 wherein the characteristic of the plastic is selected from conductivity and platability.

26. The rotor assembly of claim 24 wherein the inner portion is the product of a first shot molding step using a first mold, and the outer portion is the product of a second shot molding step using a second mold, wherein the inner portion is a component of the mold of the second shot.
